(19) United States
(12) Patent Application Publication
(10) Pub. No.: US 2015/0345541 A1
(43) Pub. Date: Dec. 3, 2015

(54) REINFORCEMENT INTEGRATED INTO THE STRUCTURE OF WOUND COMPONENTS CONSISTING OF COMPOSITE MATERIALS AND METHOD FOR PRODUCING SAME

(71) Applicant: ENRICHMENT TECHNOLOGY COMPANY Ltd., Jülich (DE)

(72) Inventors: Dipl. Ing. Michael Sonnen, Duisburg (DE); Frank Otremba, Stolberg (DE)

(73) Assignee: Enrichment Technology Company Ltd., Jülich (DE)

(21) Appl. No.: 14/649,609

(22) PCT Filed: Dec. 9, 2013
(86) PCT No.: PCT/EP2013/075930

§ 371 Date: Jul. 28, 2015

(30) Foreign Application Priority Data
Dec. 13, 2012 (EP) 12197018.0

(51) Int. Cl. F16C 3/02; B29C 70/06; B29C 70/30

(52) U.S. Cl. CPC F16C 3/026; B29C 70/30; B29C 70/06; B29L 2031/75

(57) ABSTRACT

A component is provided with a fiber-reinforced composite area made of fiber-reinforced composite materials, comprising one or more normal areas and one or more reinforcement areas with one or more connection surfaces that are provided for purposes of connection to an appertaining force-transmission component for the introduction of a force into the component. In the normal area, the one or more fibers(s) are arranged at a first mean fiber angle relative to the direction of the introduction of force. In the reinforcement area, they are arranged at least partially at a second mean fiber angle relative to the direction of the introduction of force, and the second mean fiber angle is smaller thirst mean fiber angle. As a result, a component is put forward that has space-saving reinforced areas in order to compensate for the loads exerted on the component during operation resulting in a long service life.

### FIELD OF THE INVENTION

The invention relates to a component, comprising fiber-reinforced composite materials with reinforcement areas, also to a corresponding body of rotation in case of a rotating component, and to a method for the production of these components.

### BACKGROUND OF THE INVENTION

In the case of such components, additional loads occur at the connection sites to the drives or to the static load points, for example, in the shaft-hub-rim component chain, due to differences in the stiffness and/or density. These additional loads (static or dynamic) can lead to failure of the component or to a reduction in the capacity to withstand introductions of force, and thus to a diminished efficiency or performance of the component.

In order to reduce or eliminate these negative influences on the components, an attempt is made to absorb the load, usually by means of external reinforcements. Such external reinforcements, for example, in the form of a ring, are installed around the areas that are to be reinforced. The installation of such a reinforcement involves an additional production step, thereby increasing the production effort. Due to the relatively large distance between the external reinforcement and the site of the introduction of the load, the areas in-between are nevertheless subject to a greater load. This load can never be completely compensated for by the external reinforcement. Moreover, additional reinforcement material is necessary, which increases the material requirements for the entire component. The external reinforcement might thicken the outside of the component to such an extent that installations having such components cannot be built as compactly as would be desirable. Moreover, in the case of components made of fiber-reinforced composite materials, such an external reinforcement gives rise to internal stresses in the underlying laminate, thereby promoting delamination. With an external reinforcement made of fiber-reinforced composite material, fiber ends on the surface of the reinforcement can come loose during operation. As an alternative, materials other than materials with fibers could, of course, be used as the reinforcement. However, thanks to the material properties and production costs of fiber-reinforced composite materials, they are greatly preferred over other materials such as, for example, metal reinforcements.

### SUMMARY OF THE INVENTION

It is the objective of the present invention to put forward a component that has integrated reinforced areas in order to compensate for the loads exerted on the component during operation and that has a long service life.

This objective is achieved by a component with a fiber-reinforced composite area made of fiber-reinforced composite materials, comprising one or more normal areas and one or more reinforcement areas with one or more connection surfaces that are provided for purposes of connection to an appertaining force-transmission component for the introduction of a force into the component, whereby, in the normal area, the one or more fibers(s) are arranged at a first mean fiber angle relative to the direction of the introduction of force and, in the reinforcement area, they are arranged at least partly at a second mean fiber angle relative to the direction of the introduction of force, and the second mean fiber angle is smaller than the first mean fiber angle.

Due to the inventive structure of the reinforcement in the reinforcement areas, the reinforcement is integrated into the component and can thus completely absorb and thus compensate for the additional load if the component is designed appropriately. As a result, the integrated reinforcement is also arranged directly in the area where the load is introduced. Consequently, the load is absorbed directly at the place where it is generated. Thus, only a minimal amount of reinforcement material is needed. In particular, no reinforcement material needs to be added to the component. This makes the integrated reinforcement more cost-effective. In comparison to space-consuming large outer reinforcements according to the state of the art, the integrated reinforcement can have a more space-saving configuration, that is to say, with at least considerably less thickening of the component in the reinforcement area, which simplifies the design of application-related sheathing or coverings for the component.

The component according to the invention relates to any component that is provided in order to absorb a force that is introduced into the component by means of a force-transmission component. The loads (introductions of force) that are exerted on the component according to the invention can be, for example, static or dynamic loads. Static loads are, for example, loads resulting from a tensile load or a torsional load, which the component is supposed to counteract in a static manner. In the static case, the component or the force-transmission component is not moved by a drive. For example, a torsional load is exerted onto the component and the latter is supposed to absorb this load without undergoing intrinsic rotation or positional change. Dynamic loads are, for example, shear loads or tensile loads, a torsional load or the driving of a rotating component, which all occur in a manner varying over the course of time and/or which physically move the component in an intended way. Therefore, the component is supposed to be coupled to such a drive via a force-transmission component. The drive can cause the component to execute, for example, a lateral or a rotating motion. Examples of such dynamic loads include, among other things, the linear movement of the component in a direction of movement in order to push or pull a load, or else they include the change or maintenance of a rotation frequency for a component rotating around an axis of rotation, whereby the component is suitable to be driven so as to rotate. Here, depending on the use of the component, the drive can be suitably selected by the person skilled in the art. For example, the drives are configured pneumatically, hydraulically, electrically, mechanically or in some other suitable manner. In one embodiment, the component is provided for use as a component that rotates around an axis of rotation and that has a hollow-cylindrical shape, with the cylindrical axis as the axis of rotation, whereby the inside of the cylinder serves for purposes of connection to the force-transmission component(s). In case of a component in the form of a hollow cylinder, a force-transmission component suited for this can be a hub that is arranged inside the hollow cylinder and firmly connected to it. If the force-transmission component is connected to a shaft, the force (rotation) of the shaft is transmitted to the component via the correspondingly rotating force-transmission component via the inner connection to the component, thereby causing the component to rotate.

The fiber-reinforced composite area refers to an area or volume of the component that is made of fiber-reinforced composite materials. Such a fiber-reinforced composite material generally consists of two main components, here of fibers, embedded in a matrix material that creates the strong bond between the fibers. The fiber-reinforced composite area can be wound using one single fiber or several fibers, whereby the fibers are wound next to each other in close contact with each other. This gives rise to a fiber layer on which the fibers are wound into additional fiber layers until the fiber-reinforced composite area has acquired the desired thickness. Due to the bond, the fiber-reinforced composite material attains higher-quality properties—such as, for instance, greater strength—than each of the two individual components involved could provide on their own. The reinforcement effect of the fibers in the fiber direction occurs when the modulus of elasticity of the fibers in the lengthwise direction is greater than the modulus of elasticity of the matrix material, when the ultimate elongation of the matrix material is greater than the ultimate elongation of the fibers, and when the ultimate strength of the fibers is greater than the ultimate strength of the matrix material. All kinds of fibers such as, for example, glass fibers, carbon fibers, ceramic fibers, steel fibers, natural fibers or synthetic fibers can be used as the fibers. Thermosetting plastics, elastomers, thermoplastics or ceramic materials can be used as the matrix materials. The material properties of the fibers and matrix materials are known to the person skilled in the art, so that the person skilled in the art can select a suitable combination of fibers and matrix materials in order to produce a fiber-reinforced composite area of the component for the application in question. Here, the normal and/or reinforcement areas in the fiber-reinforced composite area can be one single fiber or several identical or different fibers. In one embodiment, the component is made entirely of fiber-reinforced composite material. Such a component has very high strength values, along with a low weight.

The first mean and second mean fiber angles are the mean angles between the direction of the introduction of force into the component and the fiber direction. In this context, the mean fiber angles can vary markedly, depending on the application in question. The mean fiber angles ensue from the calculated average of the individual fiber angles in the normal and reinforcement areas. Here, the fiber angles of the individual fiber(s) in the normal areas and/or over the reinforcement areas can certainly fluctuate, which does not necessarily increase or decrease the mean fiber angle, as long as the individual local fluctuations of the fiber angles offset each other. Particularly in the transition from a normal area to a reinforcement area (change of the fiber angle) and vice versa, the local fiber angles can differ markedly—possibly on the basis of the way the component was produced—from the mean fiber angle in the appertaining areas (normal area or reinforcement area). However, since these transition areas only make up a small fraction of the total areas (normal area or reinforcement area), in this case as well, the mean fibers angles are only negligibly influenced by the local fiber angles in the transition areas. The second mean fiber angles, which are larger than the first mean fiber angles in the reinforcement area, yield a fiber angle difference that determines the degree of the reinforcement in the reinforcement areas relative to the normal areas. Through the appropriate selection of the second mean fiber angle in the reinforcement area(s), a portion of the component can be considerably reinforced, depending on the fiber angle difference. Fibers have their greatest strength in the fiber direction. If the load introduction is brought about by a tensile force, then the second fiber angle in the reinforcement area preferably corresponds to angles within the range between 0° and the tensile direction. If the load introduction is brought about by a torsional force, then second fiber angles in the range between 45° and the longitudinal axis of the component are advantageous. In contrast, for example, in the case of rotating (turning) components, the reinforcement area is mechanically even more robust against load introductions if the fiber angle corresponds to a 90° angle relative to the axis of rotation of the component. Within the scope of the present invention, the fiber angle difference between the first mean and the second mean fiber angles as well as the absolute first mean and second mean fiber angles can be suitably selected by the person skilled in the art for the application in question and the reinforcement requirements. If the component has several reinforcement areas, the fibers can be arranged in different reinforcement areas with the same or with different second mean fiber angles. Here, for example, with different introductions of force in different reinforcement areas, the fiber arrangement could be adapted to the specific local introductions of force in that the second mean fiber angle in the different reinforcement areas is selected as a function of the different introduction of force. Moreover, the second fiber angle can vary in a reinforcement area from one fiber layer to another fiber layer.

The term “normal area” refers to the area of the component in which the fiber-reinforced composite material is dimensioned for the normal load of the component without the introduction of force. Therefore, in this normal area, the fibers with an orientation along the first mean fiber angle can, for instance, also diverge considerably from the direction of the introduction of force since, in the normal area, the requisite mechanical strength is not as high as in the reinforcement area.

In the reinforcement area, a locally elevated load occurs due to the introduction of force by the force-transmission component and as a result of a static or dynamic load of the component. For purposes of reinforcement vis-à-vis the normal areas, the fibers in the reinforcement area are wound at a second mean fiber angle that, to the greatest extent possible, brings about a fiber orientation in the direction of the introduction of force into the component, thereby translating into a higher mechanical strength of the reinforcement area as compared to the normal areas.

In one embodiment, the fibers comprise one or more elements belonging to the group of natural fibers, glass fibers, ceramic fibers, steel fibers, synthetic fibers, carbon fibers, or high-strength carbon fibers. Within the scope of the present invention, the person skilled in the art can also select other suitable fibers.

Through the integration of the reinforcement as the reinforcement area with fibers that, in the reinforcement area, merely change their orientation in comparison to the normal areas but that, for the rest, constitute continuous fibers without fiber ends in the reinforcement areas, a fiber end is prevented from being exposed (as can be the case in the state of the art with external reinforcements made of fiber-reinforced composite material). Thus, with the component that is reinforced according to the invention, no fiber ends can come loose in the reinforcement area during operation. Moreover, the integrated reinforcement reduces the tendency towards crack formation in the component.

In one embodiment, the reinforcement area has an extension that goes beyond the extension of the connection surface within which the force-transmission component is connected to the component. As a result, the tendency towards crack formation is greatly diminished, particularly in the area of the connection surface between the force-transmission component and the component.

In another embodiment, the fiber-reinforced composite area comprises several fiber layers consisting of fibers wound over each other, whereby, in the reinforcement area, the fiber layers consist alternately of fibers having first and second mean fiber angles. In this manner, the bond between the normal areas and the reinforcement areas is further enhanced since the adjacent fiber layers consist of fibers with different fiber angles and consequently, the fibers of the adjacent fiber layers are wound so as to overlap, thereby creating a strong bond with the fiber layers above or below in the reinforcement area. The reinforcement integrated in this manner reduces the internal stresses in the component that might lead to delamination.

In another embodiment, the fiber layers consisting of fibers having the second mean fiber angle have a first extension parallel to the connection surface of the component, whereby the first extensions decrease as the distance between the individual fiber layers and the connection surface increases. The fiber layer of the reinforcement area near the connection surface to the force-transmission component has to absorb the largest forces that are exerted on the component. Therefore, it is advantageous to select the extension of this fiber layer to be as large as possible. As the distance to the connection surface increases, the force introduced into the individual fiber layers decreases, so that the first extension of the fiber layers can decrease as the distance increases and, at the same time, the loads that occur can still be compensated for by the reinforced component. In a preferred embodiment, the fiber layers of the fibers having the second mean fiber angle—in the side sectional view of the reinforcement area—are arranged one above the other in a trapezoidal shape, whereby the lowermost fiber layer of the fibers having the second mean fiber angle has the largest first extension. The term trapezoidal refers to all shapes in which the extensions of the individual fiber layers taper essentially symmetrically. This special tapering shape renders the component very robust against loads. The steepness of the trapezoidal shape on the tapering legs can be adapted to the application in question.

In another embodiment, the arrangement of the fibers in the reinforcement area is configured in such a way that the geometric shape of the fiber-reinforced composite area in the reinforcement area does not diverge from the geometric shape of the adjacent normal area, whereby the reinforcement area preferably has the same thickness as the adjacent normal area(s). Since the reinforcement is integrated into the existing fiber layers by means of the changed fiber angle, any enlargement of the diameter of the component in the reinforcement area can be avoided, as a result of which the components according to the invention can be produced with an ideal structural volume (that has not been enlarged by any reinforcing measures).

In another embodiment, fibers having the first mean fiber angle are arranged in the reinforcement area, at least on the surfaces of the component facing and/or facing away from the connection surface. As a result, the integrated reinforcement is not visible towards the outside, since the fiber layers located on the appertaining surfaces do not differ—in terms of their fiber orientations—between the normal area and the reinforcement area. Thus, the component has the same surface properties towards the outside over the entire fiber-reinforced composite area. This is especially advantageous for applications of the component as a transport roller for objects that have to be transported in this manner. Such transport rollers are used, for example, in printing machines.

The invention also relates to a body of rotation having a component according to the invention to be used as a component that rotates around an axis of rotation, said component having a hollow-cylindrical shape, with the cylindrical axis as the axis of rotation and whereby the inside of the cylinder serves for purposes of connection to the force-transmission component(s) and to one or more force-transmission components that are connected inside a connection surface to the component for the introduction of force into the component, whereby the force-transmission components are each appropriately supported in a bearing via a shaft or journal, and at least one of the shafts or journals can be appropriately driven by means of a drive. The advantages described above apply likewise to the correspondingly designed bodies of rotation.

In one embodiment, the body of rotation is used as a shaft or rim in order to operate machines or components, preferably as a ship's propeller shaft, a drive shaft, a motor shaft, a gear shaft, a shaft in a printing machine, or as a rotor to store energy. The rotating components described above can be used universally for a wide variety of application purposes. Within the scope of the present invention, the person skilled in the art can also use the bodies of rotation according to the invention for other application purposes.

The invention also relates to a method for the production of a component according to the invention, comprising the following steps:

(a) a fiber layer consisting of one or more fibers is wound onto a winding mandrel, whereby the one or more fibers are arranged at least in a normal area at a first mean fiber angle relative to the intended direction of an introduction of force into the component;
(b) fibers in the same fiber layer in a reinforcement area are wound onto the winding mandrel, whereby the one or more fibers are arranged in the reinforcement area at a second mean fiber angle relative to the intended direction of an introduction of force into the component, whereby the second mean fiber angle is smaller than the first mean fiber angle;
(c) additional fiber layers consisting of one or more fibers are wound by repeating the method steps (a) and (b) until the desired shape of the component has been wound;
(d) the fiber layers are hardened and/or cooled and the winding mandrel is removed.

The above-mentioned order of the method steps does not correspond here to a time sequence. Method steps (a) and (b) can also be carried out in the reverse order. In one embodiment, after steps (b) and/or (c), an interim hardening step can be carried out for the already wound fiber layers.

In one embodiment, the method comprises the additional step that, between each fiber layer in the reinforcement area, a fiber layer consisting of one or more fibers having the first mean fiber angle is wound from one or more fibers having the second mean fiber angle. In a preferred embodiment, the method comprises the additional step that the first and last fiber layers to be wound are wound only from one or more fibers having the first mean fiber angle.

### BRIEF DESCRIPTION OF THE FIGURES

These and other aspects of the invention are shown in detail in the figures as follows:

FIG. 1 two embodiments (a) and (b) of the component according to the invention;

FIG. 2 a body of rotation with a reinforced component according to the state of the art;

FIG. 3 an embodiment of a cylindrical body of rotation with a component according to the invention, in a side sectional view;

FIG. 4 an embodiment of the fiber orientation in the normal area and in the reinforcement area in the component according to the invention, in a top view onto the top of the component;

FIG. 5 an embodiment of the fiber layers in the normal area and in the reinforcement area of a component according to the invention, in a side sectional view through the wall of the component;

FIG. 6 an embodiment of the fiber orientations and fiber layers in the normal area and in the reinforcement area of a component according to the invention, (a) in a top view onto the top of the component, and (b) in a side sectional view through the wall of the component.

### DETAILED DESCRIPTION OF THE EMBODIMENTS

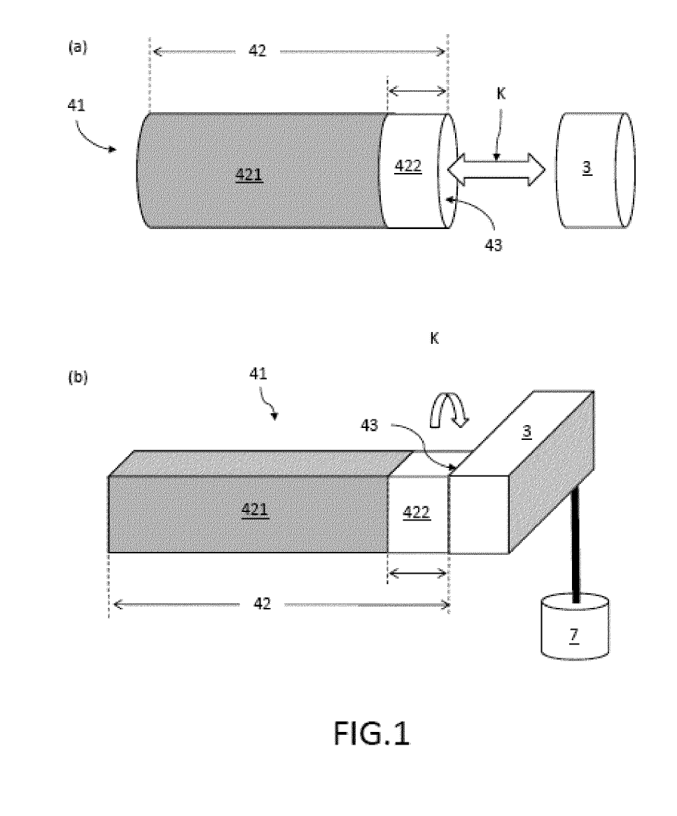

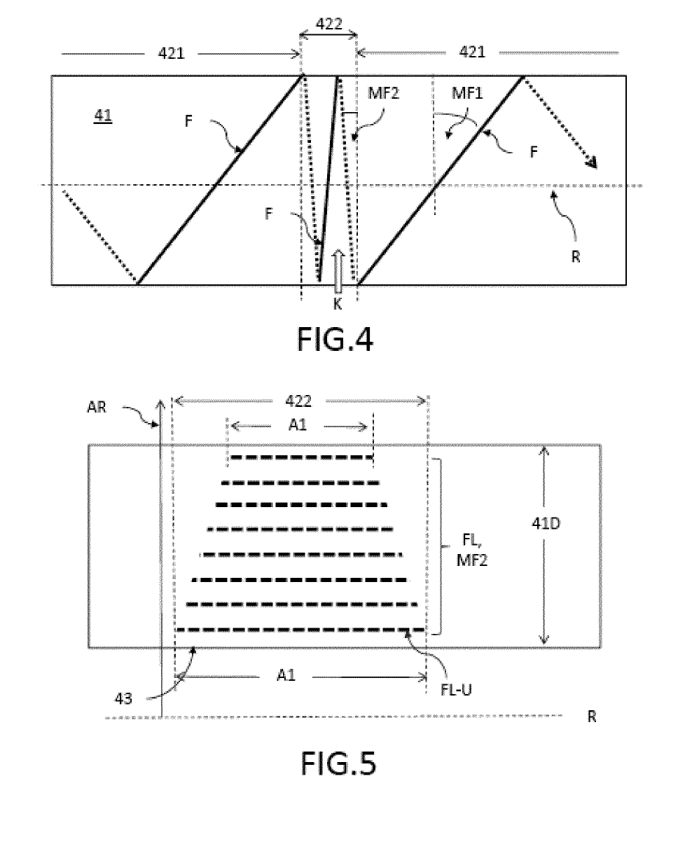

FIG. 1 shows two components 41 according to the invention, in a perspective view, with a fiber-reinforced composite area 42 made of fiber-reinforced composite materials, comprising a normal area 421 with one or more fibers F, arranged at a first mean fiber angle MF1 relative to the direction of the introduction of force K, and comprising a reinforcement area 422 with a connection surface 43, for purposes of connection to a force-transmission component 3 for the introduction of a force K into the component 41, whereby, in the reinforcement area 422, the one or more fibers F are arranged at least partially at a second mean fiber angle MF2 relative to the direction of the introduction of force K, and the second mean fiber angle MF2 is smaller than the first mean fiber angle MF1. The smaller fiber angle MF2 in the reinforcement area 422 means that the fibers F in the reinforcement area 422 are oriented in the direction of the introduction of force K since the fibers F have their greatest strength in the fiber direction. The fibers are not shown in detail here. In this embodiment, the components 41 shown are made completely of fiber-reinforced composite materials since the fiber-reinforced composite area 42 extends over the entire length of the components 41. In other embodiments, the fiber-reinforced composite area 42 can also make up only a portion of the component. For the fiber layers and fiber orientations in the components 41 shown in FIG. 1, reference is hereby made to FIGS. 4 to 6. The fiber arrangements, the fiber layers and the fiber orientations shown there can be used or arranged accordingly in the components 41 shown by way of an example in FIG. 1. FIG. 1(a) shows a component 41 on whose end there is a reinforcement area 422 that has a circular connection surface 43. Here, the force-transmission component 3 exerts a force K in the form of a tensile force or pushing force onto the component 41. The tensile force or pushing force K can be exerted here by the force-transmission component 3, for example, mechanically or electromagnetically. The force is introduced via the connection surface 43. The introduced force K is absorbed by the reinforcement area 422 in such a way that the component 41 can absorb the load by means of the via smaller second mean fiber angle MF2 (orientation of the fibers more in the direction of the introduction of force) in the reinforcement area 422, and the portions of the component 41 that are exposed to a lesser load can be configured as the normal areas 421 having the first fiber angle MF1 (if applicable, the fiber orientation in the normal area can diverge markedly from the direction of the introduction of force).

FIG. 1(b) shows another embodiment of the component 41 according to the invention. At the end of the component 41, which has a cuboidal configuration, there is a reinforcement area 422 with a rectangular connection surface 43. The force-transmission component 3 is statically connected to the component 41 at the connection surface 43 and here, it exerts a torsional force K (indicated by the curved arrow) onto the component 41. The torsional force K on the connection surface 43 is generated here, for example, mechanically, by a weight 7 that is attached to the end of the force-transmission component 3. The force is introduced via the connection surface 43 in the direction of the torque generated by the torsional force. The introduced force K is absorbed by the reinforcement area 422 in such a way that the component 41 can absorb the load via the second fibers F2 in the reinforcement area 422, and the portions of the component 41 that are exposed to a lesser load can be configured as normal areas 421 with fibers F, arranged at a first fiber angle MF1. For example, in one embodiment, since the torsional force acts at an angle of 45°±5° relative to the lengthwise direction of the component 41, the orientation of the fibers in the reinforcement area 422 can be arranged perpendicular to the connection surface 43 of the component 41 so that, in addition to its favorable mechanical properties, the reinforcement of the component 41 can be even further enhanced in the reinforcement area 422. This fiber orientation corresponds to a small second mean fiber angle MF2 relative to the direction of the introduction of force in the reinforcement area 422 when a torsional force is being exerted.

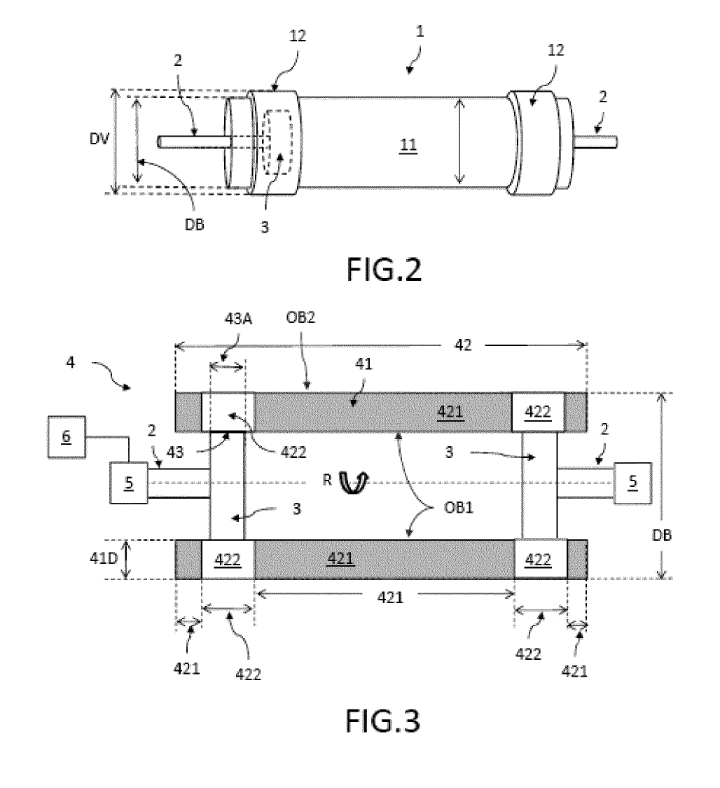

FIG. 2 shows a body of rotation 1 with a rotating component 11 according to the state of the art, which has been reinforced from the outside by means of ring-like outer reinforcements 12 in order to compensate for loads during the acceleration and deceleration of the component 11 or rotation of the component 11 at a constant speed brought about by a force acting on the drive shaft 2. The drive shaft 2, as a force-transmission component, acts upon the component 11 via a hub 3 attached to the inside of the component. The hub 3 is only shown with a broken line since, in this perspective view, it is concealed by the component 11. The component has a diameter DB without external reinforcements. If the component is installed in a machine, then a larger volume has to be kept free around the component since the external reinforcements 12 increase the effective diameter of the body of rotation 1 to a diameter DV. Thus, the component 11 cannot be installed into its surroundings in a way that saves as much space as would be possible without external reinforcements. Nevertheless, it is not possible to do without the external reinforcements 12 since otherwise, the loads that are exerted on the component 11 via the hub 3 would cause damage to the component 11, for example, crack formation in the area of the component 11 around the hub 3. Moreover, if the external reinforcements 12 are made of fiber-reinforced composite material, there is a risk that the external reinforcements 12 will break out during operation, thereby diminishing the reinforcement and correspondingly reducing the mechanical strength of the component 11, in addition to which the surroundings of the component 11 would also be soiled with loose fibers.

In contrast, FIG. 3 shows an embodiment of a cylindrical body of rotation 4 according to the invention with the component according to the invention, in this embodiment as a rotating component in a side sectional view. The component 41 has a reinforcement that is integrated into the provided fiber-reinforced composite material in appropriately configured reinforcement areas 422. The body of rotation 4 comprises a component 41 and two force-transmission components 3 that are each firmly connected inside a connection surface 43 to the component 41 in order to vary the rotation energy of the body of rotation 4, whereby the force-transmission components 3 are each suitably mounted via a shaft 2 in a bearing 5, and at least one of the shafts 2 can be appropriately driven by means of a drive 6. In this embodiment, the component 41 has a hollow-cylindrical shape with the cylinder axis as the axis of rotation R, whereby the inside of the cylinder OB1 serves for purposes of connection to the force-transmission components 3. The wall thickness 41D of the component 41 is schematically indicated by the double arrow and can vary greatly, depending on the application in question. In other embodiments, the body of rotation 4 can also comprise a force-transmission component 3 that extends through the entire area of the cylindrical component 41 or that fills up the entire inner area that is surrounded by the component. In principle, the same statements apply for these embodiments, except that the connection areas 43 vary accordingly, and the forces that are introduced into the component 41 are distributed accordingly. The component comprises a fiber-reinforced composite area 42 that is made of fiber-reinforced composite materials and embedded fibers F and that has one or more normal areas 421 with fibers F having a first mean fiber angle MF1, and that has one or more reinforcement areas 422 that are provided for purposes of connection to an appertaining force-transmission component 3 for the introduction of a load into the component 41, whereby the one or more fiber(s) F in the reinforcement are 422 is/are arranged at least at a second mean fiber angle MF2 relative to the direction of the introduction of force into the component 41, whereby the second mean fiber angle is smaller than the first mean fiber angle. For example, the second mean fiber angle is <10° relative to the direction of the introduction of force and the first mean fiber angle is >30° relative to the direction of the introduction of force. In the case of rotating bodies, the force K is introduced essentially in the radial direction so that the fibers are arranged in the reinforcement area 422 essentially in the radial direction (at an angle that is, if possible 90°, or else almost 90° relative to the axis of rotation, for example, >80° relative to the axis of rotation), and, if applicable, the fiber orientation in the normal area 421 can diverge markedly from the radial orientation (fiber orientation in the normal area at a mean angle <60° relative to the axis of rotation). In the embodiment shown here, the entire component 41 is made of fiber-reinforced composite material. Here, the reinforcement areas 422 have extensions that are parallel to the axis of rotation R and that go beyond the extension 43A of the appertaining connection surfaces 43 within which the force-transmission component 3 is connected to the component 41. In this embodiment, the appertaining force-transmission components 3 are configured to be disc-shaped, so that the connection surface 43 surrounds the surface OB1 of the component facing the connection surface 43. However, the force-transmission components 3 can also be configured to be spoke-shaped, so that there are several separate connection surfaces 43 per force-transmission component 3. Here, the reinforcement areas 422 likewise completely surround the component 41 in the area of the force transmission component 3. The arrangement of the fibers F in the reinforcement area 422 is configured in such a way that the geometric shape of the fiber-reinforced composite area 42 in the reinforcement area 422 does not diverge from the geometric shape of the adjacent normal area 421, whereby the reinforcement area 422 has the same thickness 41D as each appertaining adjacent normal areas 421. The surface of the component 41 that faces away from the connection surface 43 is referred to as the surface OB2. The body of rotation 4 shown can be used, for example, as a shaft or rim in order to operate machines or components, preferably as a ship's propeller shaft, a drive shaft, a motor shaft, a gear shaft, a shaft in a printing machine, or as a rotor to store energy.

FIG. 4 shows an embodiment of the fiber orientation in the normal and reinforcement areas 421, 422 in the component 41 according to the invention as shown in FIG. 3 (component provided for purposes of rotation around an axis of rotation R) in a top view onto the top surface OB2 of the component 41. Here, for reasons of clarity, only the orientation of the winding of an individual fiber F is shown by way of example. Of course, each fiber layer FL of the component 41 is wound in such a way that the one or more fiber(s) F per fiber layer FL is/are wound closely together or in contact with each other, and the wall of the component 41 is made up of a plurality of fiber layers FL in order to create the desired wall thickness 41D. Here, the fiber F shown is arranged in the normal area 421 at a first mean fiber angle MF1 relative to the direction of the introduction of force K into the component 41, and it is arranged in the reinforcement area 422 at a second mean fiber angle MF2 relative to the direction of the introduction of force K into the component 41, whereby the second mean fiber angle MF2 is smaller than the first mean fiber angle MF1. In the case of rotating bodies, the force K (shown by the corresponding arrow K) is introduced essentially in the radial direction so that the fibers are arranged in the reinforcement area 422 essentially in the radial direction (at an angle that is, if possible 90°, or almost 90° relative to the axis of rotation, for example, >80° relative to the axis of rotation), and, if applicable, the fiber orientation in the normal area 421 can diverge markedly from the radial orientation (fiber orientation in the normal area having a mean angle <60° relative to the axis of rotation). The solid line of the fiber F depicts the directly visible fiber F on the facing surface of the component 41 that is to be rotated, whereas the dotted line depicts the fiber F on the non-facing side of the surface of the component 41. The mean fiber angles can vary considerably, depending on the application purpose. Wherever the second mean fiber angle MF2 is smaller than the first mean fiber angle MF1, the fiber angle difference makes a contribution to the degree of reinforcement in the reinforcement areas 422. Through the favorable selection of the fiber angle MF2 in the reinforcement area 422, the component 41 can be greatly reinforced. Fibers have the greatest strength in the fiber direction. Thus, the smaller the fiber angle MF2 is, the more mechanically robust the reinforcement area 422 is against loads. Ideally, the fibers in the reinforcement area have an orientation in the direction of the introduction of force K, which would correspond to a second fiber angle=0°. In one embodiment, the reinforcement area 422 is arranged between two normal areas 421, as is shown in FIG. 4.

The fibers F shown in FIG. 4 have essentially the same second fiber angle in the reinforcement area 422 so that the second fiber angle of the fibers F in the middle of the reinforcement area 422 differs only slightly from the second mean fiber angle MF2. The slight difference is caused by the transition of the fiber orientation from the normal area 421 having the first mean fiber angle to the second fiber angle in a transition area of the reinforcement area 422 adjacent to the normal area 421. Consequently, the plotting of all second fiber angles over the location on the component (also referred to as the distribution of the fiber angles) has only one single minimum in the reinforcement area 422. Therefore, the distribution of the fiber angles over the location on the component has a descending area in a transition area in the reinforcement area 422 adjacent to the normal area 421, where the fiber angle decreases from the first fiber angle to the second fiber angle, whereas the distribution in the area of the middle of the reinforcement area 422 has a constant value that is equal to the second fiber angle in the reinforcement area 422.

FIG. 5 shows an embodiment of the extension of the fiber layers FL parallel to the connection surface 43 in the reinforcement area 422 of the component 41 according to the invention in a side view. Here, the fiber layers FL with fibers F having a second mean fiber angle MF2 each have a first extension A1 parallel to the connection surface 43, whereby the first extensions A1 decrease as the distance AR between the individual fiber layers FL and the connection surface 43 increases. Here, the fiber layers FL of the fibers F having the second mean fiber angle MF2—in the side sectional view of the reinforcement area 422—are arranged one above the other in a trapezoidal shape, whereby the lowermost fiber layer FL-U with these fibers F has the largest first extension A1. The fiber layer of the reinforcement area 422 near the connection surface 43 to the force-transmission component 3 has to absorb the largest forces that are exerted on the component 41. Therefore, it is advantageous to select the extension of this fiber layer FL-U to be as large as possible. As the distance AR to the connection surface 43 increases, the force introduced into the individual fiber layers FL decreases, so that the first extension A1 of the fiber layers FL with fibers F having a second mean fiber angle MF2 can decrease as the distance AR increases and, at the same time, the loads that occur can still be compensated for by the reinforced component 41. This special tapering trapezoidal shape shown in FIG. 5 renders the component 41 very robust against loads. The steepness of the trapezoidal shape on the tapering legs can be adapted to the application in question. The decreasing first extensions A1 also strengthen the bond between the adjacent fiber layers FL even further. In another embodiment, the extension A1 of the fiber layers FL can also decrease non-trapezoidally as the distance AR increases, insofar as this other shape is likewise suitable for the application in question. Here, the fiber layers in the reinforcement area 422 can consist exclusively of fiber layers FL having the second mean fiber angle MF2, or else in component, they can particularly consist of fiber layers FL with fibers F having a first mean fiber angle MF1 relative to the axis of rotation. In a preferred embodiment, the fibers F of the fiber layers FL alternately have a first mean fiber angle MF1 and a second mean fiber angle MF2 in the reinforcement area 422. The shape of the reinforcement area shown here can be used for static loads as well as for dynamic loads in the reinforcement area.

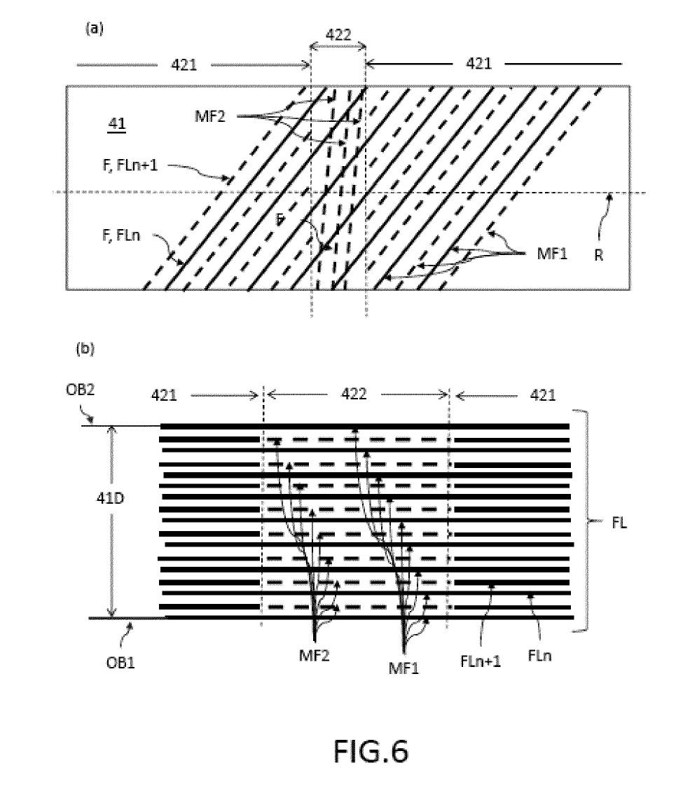

FIG. 6 shows an embodiment of the fiber orientations and fiber layers FL in the normal area 421 and in the reinforcement area 422 of a component 41 according to the invention, (a) in a top view onto the top surface OB2 of the component 41, and (b) in a side sectional view through the wall of the component 41 having a wall thickness 41D. In FIG. 6(a), the wound fibers F for two adjacent fiber layers FLn and FLn+1 are shown schematically. The position of these adjacent fiber layers in the wall of the component 41 is without significance for the schematic representation here. For reasons of clarity, the windings are shown at a large distance from each other. In actual components 41, the fibers F of a fiber layer FL are wound closely together or in direct contact with each other. Moreover, the different fiber layers FL are wound directly onto each other so that the adjacent fiber layers FLn and FLn+1 are in direct contact with each other. In this embodiment, a fiber F of the fiber layer FLn (shown as a solid line) is arranged continuously at a first mean fiber angle MF1 for the normal areas 421 and for the reinforcement area 422. On this fiber layer FLn, the next fiber layer FLn+1 with a fiber F is arranged at a first mean fiber angle MF1 in the normal areas 421 and at a second mean fiber angle MF2 in the reinforcement area 422, so that the fibers F of the fiber layers FLn and FLn+1 in the reinforcement area 422 have a fiber angle difference, so that the fibers F additionally overlap (intersect), which considerably enhances the bond between the fiber layers FLn and FLn+1. In FIG. 6(b), the corresponding structure of the fiber layers FL is shown in a side sectional view. Here, the fiber-reinforced composite area 42 in the normal areas 421 as well as in the reinforcement area 422 comprises continuous fiber layers FL consisting of fibers F wound over each other, whereby the fiber layers FL consist of fibers F having a first fiber angle MF1 in the normal area 421, and the fiber layers FL in the reinforcement area 422 each consist alternately of fibers F having a first fiber angle MF1 (shown as solid lines and designated, for example, as FLn) and of fibers F having a second fiber angle MF2 (shown here as broken lines and designated as fiber layer FLn+1). The number of fiber layers FL shown here serves only to illustrate the fiber layer structure. In most components 41, the number of fiber layers FL will be considerably larger than what is shown here. The number of fiber layers is generally (this also applies to the other figures) determined on the basis of the fiber thickness and the desired wall thickness 41D of the component 41.

Through the integrated arrangement of the fibers F having the second fiber angle MF2 in the reinforcement area 422 into the existing fiber layer structure of the normal areas 421, the geometrical shape of the fiber-reinforced composite area 42 in the reinforcement area 422 does not diverge from the geometric shape of the adjacent normal area 421. In particular, the reinforcement area 422 has the same thickness 41D as the adjacent normal areas 421. Thus, the component 41 according to the invention, with its excellent robustness against mechanical loads, can be installed in the appertaining machine environment in a very space-saving manner. Moreover, in this embodiment, fibers F having a first mean fiber angle MF1 are arranged in the reinforcement area 422 on the surfaces of the component 41 facing OB1 and/or facing away OB2 from the connection surface 43. Consequently, the component 41 has the same surface properties over the entire surfaces OB1 and OB2. Thus, the application properties of the component 41 are not influenced by the positioning of the reinforcement areas 422. As a result, the bond between the normal areas 421 and the reinforcement areas 422 is greatly increased, since the adjacent fiber layers FL have a mean fiber angle difference that is the same as the difference between the second mean fiber angle MF2 and the first mean fiber angle MF1, and thus overlap. As a result, a strong bond is created between adjacent fiber layers FL in the reinforcement area 422. The reinforcement integrated in this manner reduces the internal stresses in the component 41 that might lead to delamination.

The embodiments shown here constitute merely examples of the present invention and therefore must not be construed in a limiting fashion. Alternative embodiments considered by the person skilled in the art are likewise encompassed by the scope of protection of the present invention.

### LIST OF REFERENCE NUMERALS

1 body of rotation according to the state of the art
11 component according to the state of the art
12 external reinforcement of the component according to the state of the art
2 (drive) shaft or journal
3 force-transmission component (for example, hub)
4 body of rotation according to the invention
41 component according to the invention
41D wall thickness of the component
42 fiber-reinforced composite area
421 normal area in the fiber-reinforced composite area
422 reinforcement area in the fiber-reinforced composite area
43 connection surface between the force-transmission component and the component
43A extension of the connection surface parallel to the axis of rotation
5 bearing of the shaft
6 drive used to drive the shaft
7 weight
A1 first extensions of the fiber layers having a second fiber angle parallel to the axis of rotation
AR distance to the axis of rotation
DB diameter of the component
DV diameter of the component with external reinforcement
F fiber
FL fiber layer(s)
FLn any n^{th} fiber layer in the fiber-reinforced composite
FLn+1 a fiber layer that is adjacent to FLn
FL-U lowermost fiber layer with fibers having a second fiber angle
K introduction of force (direction of the introduction of force)
MF1 first mean fiber angle of the fibers
MF2 second mean fiber angle of the fibers
OB1 surface of the component facing the axis of rotation, inside of the cylinder
OB2 surface of the component facing away from the surface of the component
R axis of rotation

1. A component with a fiber-reinforced composite area made of fiber-reinforced composite materials, comprising one or more normal areas and one or more reinforcement areas with one or more connection surfaces that are provided for purposes of connection to an appertaining force-transmission component for the introduction of a force into the component, whereby, in the normal area, the one or more fibers(s) are arranged at a first mean fiber angle relative to the direction of the introduction of force and, in the reinforcement area, they are arranged at least partially at a second mean fiber angle relative to the direction of the introduction of force, and the second mean fiber angle is smaller than the first mean fiber angle.

2. The component according to claim 1, characterized in that the reinforcement area has an extension that goes beyond the extension of the connection surface within which the force-transmission component is connected to the component.

3. The component according to claim 1, characterized in that the fiber-reinforced composite area comprises several fiber layers consisting of fibers wound over each other, whereby, in the reinforcement area, the fiber layers each alternately consist of fibers having first and second mean fiber angles.

4. The component according to claim 3, characterized in that the fiber layers consisting of fibers having the second mean fiber angle have a first extension parallel to the connection surface of the component, whereby the first extensions decrease as the distance between the individual fiber layers and the connection surface increases.

5. The component according to claim 4, characterized in that the fiber layers of the fibers having the second mean fiber angle—in the side sectional view of the reinforcement area are arranged one above the other in a trapezoidal shape, whereby the lowermost fiber layer of the fibers having the second mean fiber angle has the largest first extension.

6. The component according to claim 1, characterized in that the arrangement of the fibers in the reinforcement area is configured in such a way that the geometric shape of the fiber-reinforced composite area in the reinforcement area does not differ from the geometric shape of the adjacent normal area, whereby the reinforcement area has the same thickness as the adjacent normal area(s), and the diameter of the component in the reinforcement area is not enlarged as compared to the diameter in the normal area.

7. The component according to claim 1, characterized in that fibers having the first mean fiber angle are arranged in the reinforcement area at least on the surfaces of the component facing and/or facing away from the connection surface.

8. The component according to claim 1, characterized in that the one or more fibers comprise one or more elements belonging to the group of natural fibers, glass fibers, ceramic fibers, steel fibers, synthetic fibers, carbon fibers, or high-strength carbon fibers.

9. The component according to claim 1, characterized in that the component is completely made of a fiber-reinforced composite material.

10. The component according to claim 1, characterized in that the component is provided for use as a component that rotates around an axis of rotation and that has a hollow-cylindrical shape, with the cylindrical axis as the axis of rotation, whereby the inside of the cylinder is provided for purposes of connection to the force-transmission component(s).

11. A body of rotation (4) having a component (41) according to claim 10 and one or more force-transmission components (3) that are connected within a connection surface (43) to the component (41) for the introduction of a force into the component (41), whereby the force-transmission components (3) are each appropriately supported via a shaft or journal (2) in a bearing (5) and at least one of the shafts or journals (2) can be appropriately driven by means of a drive (6).

12. The body of rotation according to claim 11, characterized in that the body of rotation is used as a shaft or rim in order to operate machines or components, preferably as a ship's propeller shaft, a drive shaft, a motor shaft, a gear shaft, a shaft in a printing machine, or as a rotor to store energy.

13. A method for the production of a component according to claim 1, comprising the following steps:
(a) winding a fiber layer consisting of one or more fibers onto a winding mandrel, whereby the one or more fibers are arranged at least in a normal area at a first mean fiber angle relative to the intended direction of an introduction of force into the component;
(b) winding fibers in the same fiber layer in a reinforcement area onto the winding mandrel, whereby the one or more fibers are arranged in the reinforcement area at a second mean fiber angle relative to the intended direction of an introduction of force into the component, whereby the second mean fiber angle is smaller than the first mean fiber angle;
(c) winding additional fiber layers consisting of one or more fibers by repeating the method steps (a) and (b) until the desired shape of the component has been wound;
(d) allowing the fiber layers to harden and/or cool and removing the winding mandrel.

14. The method according to claim 13, comprising the additional step that, between each fiber layer in the reinforcement area consisting of one or more fibers having the first mean fiber angle is wound from one or more fibers having the second mean fiber angle.

15. The method according to claim 14, comprising the additional step that the first and last fiber layers to be wound are wound only from one or more fibers having the first mean fiber angle.
